(19) United States
(12) Patent Application Publication
(10) Pub. No.: US 2026/0196747 A1
(43) Pub. Date: Jul. 9, 2026

(54) DEVICE FOR THE ELECTRICAL CONTACTING OF A HEATING CONDUCTOR

(71) Applicant: Schaeffler Technologies AG & Co. KG, Herzogenaurach (DE)

(72) Inventors: Frank BOHNE, Sülzetal (DE); Jan HODGSON, Troisdorf (DE)

(21) Appl. No.: 19/130,683

(22) PCT Filed: Nov. 6, 2023
(86) PCT No.: PCT/EP2023/080751

§ 371 Date: May 16, 2025

(30) Foreign Application Priority Data
Nov. 18, 2022 (DE) 10 2022 212 355.7

(51) Int. Cl. H01R 4/50; F01N 3/20

(52) U.S. Cl. CPC H01R 4/5083; F01N 3/2013

(57) ABSTRACT

A device for the electrical contacting of a heating conductor through a housing of an exhaust gas line, having an electrical conductor, which is formed as a metal bolt, a metal outer sleeve, through which the electrical conductor is fed, and an insulator, which is arranged between the electrical conductor and the outer sleeve, wherein the outer sleeve is integrally bonded to the housing, wherein the heating conductor is formed by a metallic honeycomb body which is arranged inside the housing, wherein exhaust gas can flow through the housing along a main throughflow direction which corresponds to the axial extent of the housing, wherein the electrical conductor is aligned along the axial direction of extent of the housing.

### CROSS REFERENCE TO RELATED APPLICATIONS

This is a U.S. national stage of Application No. PCT/EP2023/080751 filed Nov. 6, 2023. Priority is claimed on German Application No. DE 10 2022 212 355.7 filed Nov. 18, 2022, the contents of which are incorporated herein by reference.

### BACKGROUND OF THE INVENTION

### 1. Field of the Invention

The disclosure relates to a device for the electrical contacting of a heating conductor through a housing of an exhaust gas line, having an electrical conductor, which is formed as a metal bolt, a metal outer sleeve, through which the electrical conductor is fed, and an insulator, arranged between the electrical conductor and the outer sleeve, wherein the outer sleeve is integrally bonded to the housing, wherein the heating conductor is formed by a metallic honeycomb body arranged inside the housing, and wherein exhaust gas can flow through the housing along a main throughflow direction which corresponds to the axial extent of the housing.

### 2. Description of the Related Art

Nowadays, electrical heating elements are often used to heat exhaust gases in an exhaust gas line downstream of an internal combustion engine, or the exhaust gas flowing in an exhaust gas line. The aim here is to more quickly reach a temperature threshold from which effective transformation of the pollutants entrained in the exhaust gas can take place. This is necessary because the catalytically active surfaces, used for exhaust gas aftertreatment, of the catalytic converters installed in the exhaust gas line only allow sufficient conversion of the respective pollutants from a minimum temperature, known as the light-off temperature.

The known solutions in the prior art include what are known as heated catalytic converters, which have a metallic structure connected to a voltage source or a metal-coated ceramic structure that can be heated up by exploiting ohmic resistance.

For the purpose of electrically contacting the heatable structure, an electrical conductor must be fed in through the housing of the exhaust gas line, or of a catalytic converter arranged in the exhaust gas line, at at least one point. It must be ensured here that the feedthrough is gas-tight, and also that there is electrical insulation between the housing and the electrical conductor, and that sufficient durability is assured. The electrical conductor is often formed from a solid material, such as for example a metal bolt.

DE 10 2012 110 098 B4 discloses a method for producing an electrical feedthrough for the power supply of an electrical exhaust-operated air heating in a motor vehicle. The feedthrough has an outer tube, with an electrical conductor passing through the interior thereof. The electrical conductor protrudes beyond the outer tube at at least one of the end faces of the outer tube. The electrical conductor is surrounded in the interior of the outer tube by an insulating material. The feedthrough is created here by trimming a compressed rod material to length, wherein in each case areas of the portion functioning as the outer tube and of the portion functioning as the insulating material are removed by machining methods in order to thus create an electrical feedthrough of the desired length with a desired projection of the electrical conductor beyond the outer tube.

The contacting of the heating conductor inside the housing takes place by way of the attachment of the metallic structure forming the heating conductor to the axial end side of the bolt. This is due to the fact that the electrical feedthrough takes place in the radial direction of the housing.

A disadvantage of the devices known in the prior art is that the radial alignment of the electrical feedthrough leads to an increased installation space requirement. This is disadvantageous in particular because auxiliary electric heaters are increasingly being used in direct proximity to the internal combustion engine, where the available installation space is extremely limited. In addition to the radial alignment and arrangement of the electrical feedthrough itself, the electrical contacting of the inner conductor itself with an electrical supply line outside the housing is also difficult on account of the small available installation space.

### SUMMARY OF THE INVENTION

Therefore, the problem addressed by one aspect of the present invention is that of providing a device for the electrical contacting of a heating conductor arranged in an exhaust gas line that is optimized with respect to the installation space requirement.

An exemplary aspect of the invention relates to a device for the electrical contacting of a heating conductor through a housing of an exhaust gas line, having an electrical conductor, which is formed as a metal bolt, having a metal outer sleeve, through which the electrical conductor is fed, and having an insulator, which is arranged between the electrical conductor and the outer sleeve, wherein the outer sleeve is integrally bonded to the housing, wherein the heating conductor is formed by a metallic honeycomb body which is arranged inside the housing, wherein exhaust gas can flow through the housing along a main throughflow direction which corresponds to the axial extent of the housing, wherein the electrical conductor is aligned along the axial direction of extent of the housing.

The housing is usually formed by a tube that can be flowed through along a main throughflow direction. This direction corresponds to the axial extent of the housing. According to one aspect of the invention, the electrical conductor is aligned along this axial direction. It may at the same time also be set at a small angle to this axial direction. The electrical conductor thus penetrates the housing on an axial outer surface of the housing and not on a radially aligned outer surface. This allows a substantially space-saving arrangement of the electrical conductor and thus of the entire electrical feedthrough.

It is particularly advantageous if the electrically conductive contact between the heating conductor and the electrical conductor is formed on a radially aligned surface of the electrical conductor. The heating conductor, which is usually of a disk-shaped form and is arranged within the housing, is formed by a metallic honeycomb body. Here, the honeycomb body is formed from a plurality of metal foils stacked one on top of the other, which are of a smooth and/or at least partially structured form. The stack of layers produced in this way is turned about at least one point of rotation and forms the heating conductor referred to as a heating disk. The packs of wound-up layers run out at at least one point on the outer circumference of the heating disk and form a free end. At this free end, the electrical contacting of the heating conductor by the electrical conductor takes place.

Owing to the arrangement according to an aspect of the invention of the electrical conductor in an axial direction, the contact surface between the free end of the heating conductor and the electrical conductor is preferably formed on a radial end face of the electrical conductor.

It is also advantageous if the electrical conductor has at its end projecting into the housing a flattened surface which is aligned in the radial direction of the electrical conductor.

In the basic state, the electrical conductor formed as a metal bolt has a cylindrical shape at its end region projecting into the housing. In order to produce advantageous electrical contacting with the heating conductor, it is advantageous if the cylindrical outer surface is flattened on at least one portion of the electrical conductor. The surface of the electrical conductor that is aligned in the radial direction serves as a contact surface with the heating conductor.

A preferred exemplary aspect is characterized in that the flattened surface has at least one depression acting as a solder reservoir. The flattened surface of the electrical conductor is preferably brought into contact with the free end of the heating conductor and durably integrally bonded by a soldering process. In order to make this into a reliable, and in principle simplified, procedure, it is advantageous if the flattened surface has a depression which can be filled with a solder material. The depression may at the same time extend along the entire flattened surface, or else be formed only in portions.

It is also preferable if the electrical conductor has at its end region projecting into the housing a bevel which reduces the size of the axial end face of the electrical conductor and runs from the axial end face toward the flattened surface.

The bevel serves for producing an insertion bevel. As a result, in particular the axial end face of the electrical conductor is reduced in size. Moreover, the bevel is aligned in such a way that it merges from the axial end face of the electrical conductor into the flattened surface aligned in the radial direction. When the electrical conductor is inserted into the housing, the free end of the heating conductor is thus advantageously guided toward the flattened surface in order to contact the electrical conductor there.

Furthermore, it is advantageous if the electrical conductor has a slot which is introduced from its axial end face and passes completely through the electrical conductor in the radial direction, wherein the heating conductor is fed through this slot.

Such a slot, which preferably passes completely through the electrical conductor, forms two radial attachment surfaces on the electrical conductor. The free end of the heating conductor can be fed through this slot and connected to the electrical conductor. For this purpose, the electrical conductor engages around the free end of the heating conductor on both sides. The slot may penetrate the axial end face of the electrical conductor such that a U-shaped recepta-cle is formed by the slot.

It is furthermore advantageous if the heating conductor is fed through the slot in the electrical conductor, wherein a ceramic wedge is pushed between at least two layers of the heating conductor formed as a honeycomb body and produces a clamping between the heating conductor and the electrical conductor in the region of the slot.

In order to secure the connection between the heating conductor and the electrical conductor, it is possible to provide a clamping part which can be pushed between individual metal foils of the free end of the heating conductor and thus produces a clamping between the heating conductor and the receiving region of the electrical conductor formed by the slot.

It is also expedient if the electrical conductor is fed through the housing at a point which is arranged outside the cross section of the housing that can be flowed through. This is advantageous in order not to reduce the size of the cross-sectional area of the housing that can actu-ally be flowed through despite the axial alignment of the electrical conductor. The free end of the heating conductor is therefore preferably led out of the throughflow cross section of the housing into a further region, for example into an auxiliary chamber. The electrical contacting of the heating conductor with the electrical conductor is then produced in this region.

Advantageous developments of the present invention are described in the dependent claims and in the description of the figures that follows.

### BRIEF DESCRIPTION OF THE DRAWINGS

The invention is explained in detail below on the basis of exemplary embodiments with reference to the drawings, in which:

FIG. 1 is a perspective view of the electrical conductor with a flattened surface;

FIG. 2 is a perspective view of an electrical conductor, wherein the conductor has a slot introduced from the axial end face;

FIG. 3 is a perspective view of the electrical conductor, wherein the electrical conductor is in contact with the heating conductor by way of the radially aligned flattened surface;

FIG. 4 is a perspective view through an electrical conductor according to FIG. 2, wherein the heating conductor is fed through the slot formed;

FIG. 5 is a view of the electrical conductor with a flattened radially aligned surface, wherein the electrical conductor has a bevel at its axial end region;

FIG. 6 is an electrical conductor having a flattened radially aligned surface, wherein the surface has a depression which serves as a solder reservoir; and FIG. 7 is an electrical conductor according to FIG. 2, wherein the heating conductor fed through the slot is clamped in the slot by a ceramic wedge.

### DETAILED DESCRIPTION OF THE PRESENTLY PREFERRED EMBODIMENTS

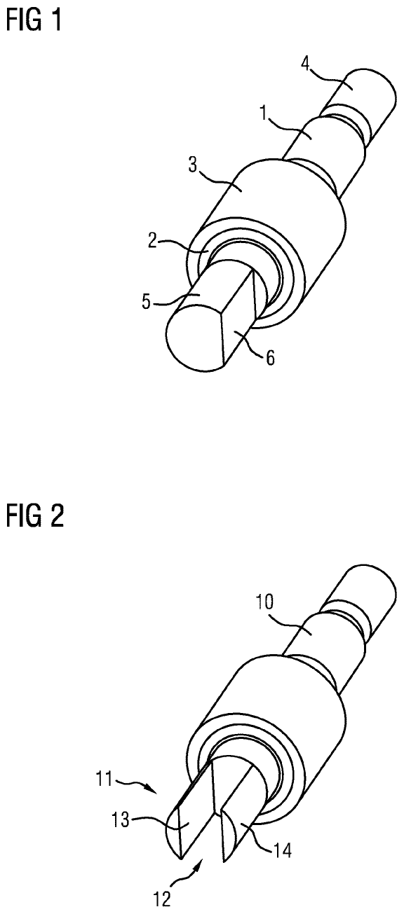

FIG. 1 shows an electrical conductor 1 formed from a metal bolt. The latter is fed through a sleeve-like insulator 2, which in turn is enclosed in a metal sleeve 3. The electrical conductor 1 has two free ends 4, 5. In the final assembled state, the free end 4 is positioned outside the housing (not shown) of the exhaust gas line. The free end 5 is positioned within the housing and serves for electrical attachment to the heating conductor (not shown).

The free end 5 is flattened over part of the axial extent of the electrical conductor 1, such that a planar surface 6 is formed on a radially aligned side of the electrical conductor 1. The surface 6 serves as a contact surface for the heating conductor (not shown).

FIG. 2 shows an alternative configuration of an electrical conductor 10. The basic construc-tion corresponds to that of the electrical conductor 1 of FIG. 1. In contrast to the flattened surface 6 in the example of FIG. 1, the electrical conductor 10 has at the free end 11 arranged within the housing a slot 12 which divides the free end region into two portions. The two portions produced by the slot 12 each form a radial surface 13, 14, which serve as a contact surface for the heating conductor (not shown).

The heating conductor, in particular the free end of the stack of layers forming the heating conductor, can be fed through the slot 12 and connected on both sides to the radially aligned surface 13, 14.

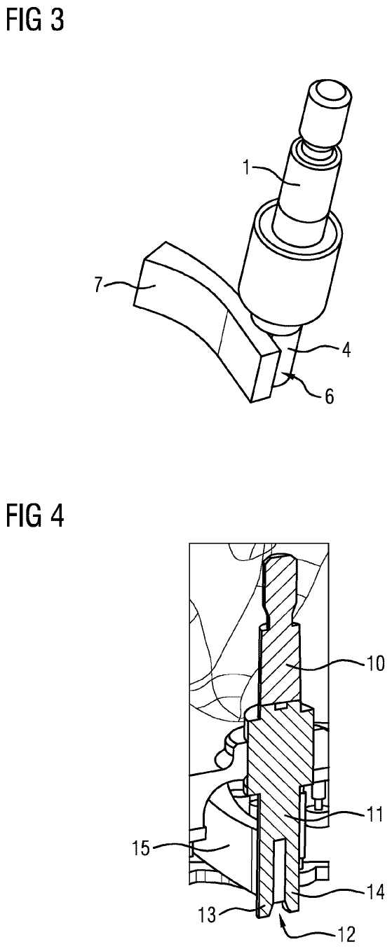

FIG. 3 shows an electrical conductor 1 analogous to FIG. 1. In FIG. 3, the free end of a stack of layers forming the heating conductor 7 is attached to the surface 6. It can be clearly seen that the contacting of the heating conductor 7 takes place on a radial outer surface 6 of the electrical conductor 1.

The free end 5 of the electrical conductor 1 having the surface 6 engages in the axial direction into the plane in which the heating conductor 7 is arranged.

FIG. 3 shows an electrical conductor 10 according to FIG. 2. In FIG. 4, a free end of the stack of layers 15 is inserted into the slot 12 and connected to the electrical conductor 10 by the contact surfaces 13, 14 formed by the slot. It can also be clearly seen here that the attachment of the electrical conductor 10 to the heating conductor 15 takes place by way of radially aligned contact surfaces 13, 14 of the electrical conductor 10.

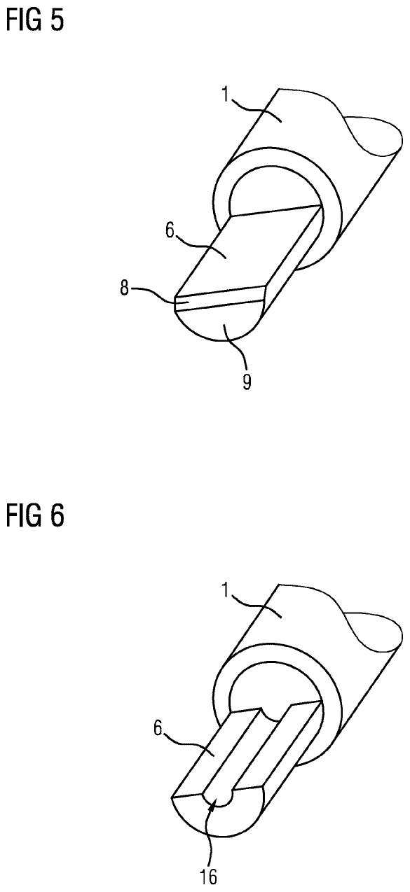

FIG. 5 shows an alternative configuration of an electrical conductor 1 as shown in FIG. 1. In addition to the radially aligned surface 6, also formed on the free end 5 of the electrical conductor 1 is a beveled surface 8, which reduces the axial end face 9 of the electrical conductor and forms a transition to the radially aligned surface 6.

The bevel 8 serves as an insertion aid and is intended to ensure that, when the electrical conductor 1 is inserted, the free end of the heating conductor does not catch the axial end face 9 but instead slides past on it and comes into contact with the radially aligned surface 6.

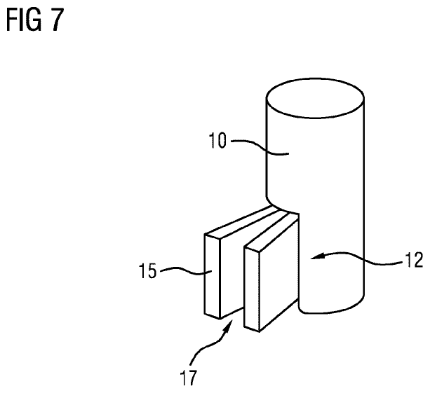

FIG. 6 shows an alternative configuration of the electrical conductor 1 of FIG. 1. In addition, the radially aligned surface 6 has a depression 16, which serves as a solder reservoir. In the exemplary embodiment of FIG. 6, the depression 16 is formed by a bore introduced from the axial end face.

FIG. 7 shows an alternative configuration of an electrical conductor 10, wherein a free end of a heating conductor 15 is inserted in the slot 12. In addition, a clamping element 17, a wedge in the case of FIG. 7, is pushed between the layers of the heating conductor 15, as a result of which a clamping of the layers of the heating conductor 15 in the slot 12 of the electrical conductor 10 is produced. This additionally increases the stability of the connection.

The clamping element 17 is preferably formed from a ceramic and thus electrically non-con-ductive material.

The different features of the individual exemplary embodiments can also be combined with one another.

The exemplary embodiments of FIGS. 1 to 7 especially have no limiting character and serve to illustrate the concept of the invention.

Thus, while there have shown and described and pointed out fundamental novel features of the invention as applied to a preferred embodiment thereof, it will be understood that various omis-sions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recog-nized that structures and/or elements and/or method steps shown and/or described in connec-tion with any disclosed form or embodiment of the invention may be incorporated in any other disclosed or described or suggested form or embodiment as a general matter of design choice. It is the intention, therefore, to be limited only as indicated by the scope of the claims appended hereto.

1.-17. (canceled)

18. A set, comprising:
a first stator unit, having:
a first interconnection device configured to interconnect a stator winding to form a delta circuit, the first interconnection device having three connection rails configured to contact in each case one phase strand of the stator winding; and
an insulation housing with a receiving structure configured to receive the three connection rails; and
a second stator unit, having:
a second interconnection device configured to interconnect a stator winding to form a star point circuit, the second interconnection device having three connection rails configured to contact in each case one phase strand of the stator winding,
a star point rail configured to contact all phase strands of the stator winding; and
an insulation housing with a receiving structure configured to receive the three connection rails and the star point rail;
wherein the receiving structures of the first and second interconnection devices are of identical design, and/or wherein the insulation housings of the first and second interconnection devices are identical parts.

18. The set as claimed in claim 18,
wherein the receiving structure has three receiving portions for the three receiving rails on an upper side of the insulation housing and a further receiving portion for the star point rail on a lower side of the insulation housing, and
wherein the further receiving portion of the first interconnection device is unoccupied and the further receiving portion of the second interconnection device is occupied by the star point rail.

19. The set as claimed in claim 18, wherein the first and the second stator unit each comprise a stator body and a stator winding, the stator body and/or the stator winding of the first and the second stator unit being designed as identical parts.

20. The set as claimed in claim 18, wherein the three connection rails of the first and the second interconnection device each have a group of connection lugs configured to connect at least one winding end of a respective phase strand and a respective rail portion for connection to power electronics, the rail portions and at least some of the connection lugs of the first and second interconnection devices forming a common sub-portion.

21. The set as claimed in claim 20, wherein the first and second interconnection devices can be arranged and/or are arranged in an installation situation in a fixed angular position, the connection lugs of the three connection rails of the first interconnection device being arranged in a first connection region of n stator slots.

22. The set as claimed in claim 21, wherein the star point rail of the second interconnection device has a group of connection lugs configured to connect at least one winding end per phase strand and a connection portion configured to connect the connection lugs to form a star point, the connection lugs of the three connection rails of the second interconnection device and the connection lugs of the star point rail of the second interconnection device being arranged in a second connection region of n stator slots.

23. The set as claimed in claim 22, wherein the first and/or second connection region extends in an angular range of more than 90 degrees.

24. The set as claimed in claim 21, wherein an angular distance between the connection lugs corresponds to an angular distance between the stator slots.

25. The set as claimed in claim 20, wherein all connection lugs of the first and the second interconnection device are each located on a pitch circle, the connection lugs of the three connection rails of the first interconnection device being arranged in groups one after an other in a circumferential direction and the connection lugs of the three connection rails of the second interconnection device being arranged in groups alternately with respect to the connection lugs of the star point rail.

26. The set as claimed claim 20, wherein the rail portions of the three connection rails of the first interconnection device are each connected to connection lugs in a center of a respective associated group and/or the connection portion of the star point rail of the second interconnection device is in each case connected to connection lugs in the center of the respective associated groups.

27. The set as claimed in claim 22, wherein the connection lugs of the first interconnection device and the winding ends of the stator winding of the first stator unit are offset in a circumferential direction by at least one stator slot with respect to the connection lugs of the second interconnection device and the winding ends of the stator winding of the second stator unit and/or the first and second connection regions are offset in the circumferential direction by at least one stator slot.

28. A stator unit, comprising:
an interconnection device, the interconnection device having an insulation housing with a receiving structure, the receiving structure being formed for receiving three connection rails in order to form the interconnection device as a delta circuit, or for receiving three connection rails and a star point rail in order to form the interconnection device as a star circuit.

29. A method for manufacturing a stator unit comprising:
Providing a stator body, a stator winding and an interconnection device for interconnecting the stator winding to form a delta connection or a star connection;
when a delta circuit is to be produced, the stator winding is inserted into the stator body in a predefined first angular position and the interconnection device is arranged in a fixed angular position relative to the stator body, at least one winding end of a phase strand being contacted with a respective connection rail of the interconnection device in order to form a first stator unit; and
if a star connection is to be produced, the stator winding is inserted into the stator body in a predefined second angular position, the interconnection device is supplemented by a star point bar and the interconnection device is arranged in a defined angular position relative to the stator body,
wherein, to form a second stator unit, in each case at least one winding end of a phase strand is contacted with in each case one connection rail of the interconnection device and in each case at least one winding end of each phase strand is contacted with the star point rail.

30. The method as claimed in claim 29, wherein the connection rails are shortened to form free areas for the star point rail.

31. The method as claimed in claim 30, wherein the stator winding is inserted in the first angular position offset by at least one stator slot in a circumferential direction relative to the second angular position.

32. The set as claimed in claim 23, wherein the first and/or second connection region extends in an angular range of less than 180 degrees.

33. The set as claimed in claim 22, wherein the first and/or second connection region extends in an angular range of less than 180 degrees.
